(19) United States
(12) Patent Application Publication
(10) Pub. No.: US 2007/0226112 A1
(43) Pub. Date: Sep. 27, 2007

(54) International financing and investment structure

(76) Inventors: Chi Hsiu Hsin, Franklin Square, NY (US); Chai Im, Scarsdale, NY (US)

Correspondence Address: FULBRIGHT & JAWORSKI, LLP, 666 FIFTH AVE, NEW YORK, NY, 10103-3198, US

(21) Appl. No.: 11/387,543

(22) Filed: Mar. 22, 2006

(51) Int. Cl. G06Q 40/00

(52) U.S. Cl. 705/36 R

(57) ABSTRACT

The financing and investment structure of the present invention comprises a financing instrument, which is based on an investing entity's investment in a domestic company holding interests in a plurality of foreign companies, for investing by the investing entity in one of foreign companies. The domestic company gives the investing entity the right or warrant to invest, acquire, control or manage one or more foreign companies.

### FIELD OF THE INVENTION

The present invention relates to an international financing and investment structure, particularly, a financing and investment structure that enables an investor or a company to safely and efficiently invest and finance a transaction in a foreign country.

### BACKGROUND OF INVENTION

International transactions, e.g., mergers, acquisitions, etc., are on the rise all over the world. Companies can grow only so much organically, so they seek to invest or acquire another company to sustain their growth. Big multi-national companies generally have vast resources to undertake foreign acquisitions to establish a presence in such foreign markets or to tap into their lower cost structure. For example, many software or computer service companies have established a presence in India or acquired Indian software companies to lower their cost structure to be competitive in the global market place. Also, American and European car companies have invested in or acquired Asian car companies to acquire their ability to make small affordable cars.

Such foreign acquisitions or investments are also desirable for smaller or mid-size companies, but they are cost prohibitive under the current international financing and investment structure. Their cost structures are also under tremendous competitive pressure from foreign competitions, particularly from underdeveloped countries. However, the high cost and high risk involved in foreign acquisitions and investments prohibits such small and mid-size companies from pursuing such international transactions. The company must find a suitable foreign target company, conduct due diligence on that foreign target company and deal with host of issues, such as regulations and rules involving transfer of foreign currency, investing in foreign companies, etc.

Therefore, it is desirable to have an international financing and investment structure that enables any investor and company to efficiently participate in a foreign acquisition and investment.

### SUMMARY OF THE INVENTION

The present invention provides a financing and investment structure that facilitates international investment and acquisition that overcomes the cost prohibitive problem associated with currently available investment structure.

In accordance with an embodiment of the present invention, the financing and investment structure, as aforesaid, comprises a financing instrument in foreign currency based on investment in a private or publicly traded domestic company (“domestic company”) holding interests in a plurality of private and/or public foreign companies, including state owned enterprises, to enable an investing entity to invest in at least one of the foreign companies.

In accordance with an embodiment of the present invention, the method of investing in a public or private foreign company, comprising the steps of investing, selecting and arranging financing. An investing entity invests in a private or publicly traded domestic company (“domestic company”) holding interests in a plurality of public and/or private foreign companies, including state owned enterprises (“foreign companies”). The domestic company essentially gives the investing entity the right or warrant to invest, acquire, control or manage one or more foreign companies. The investing entity based on its investment in the domestic company selects at least one foreign company from the plurality of foreign companies. The domestic company arranges direct or indirect financing in a jurisdiction of the selected foreign company, thereby enabling the investing entity to invest in the selected foreign company. Preferably, the financing amount is equal to or less than the investing entity's investment in the domestic company. In accordance with an aspect of the present invention, the financing is in a currency of the foreign company.

In accordance with an embodiment of the present invention, a computer based system for managing an investment in a foreign company comprising an investment module, a foreign company module and a financing module. The investment module processes investment by an investing entity in a domestic company holding interests in a plurality of foreign companies. The foreign company module enables the investing entity to select at least one foreign company from the plurality of public and/or private foreign companies, including state owned enterprises. Preferably, the foreign company module provides description of each foreign company, including management, business and/or financial information. The financing module arranges financing in a jurisdiction of the selected foreign company, thereby enabling the investing entity to invest in the selected foreign company. Preferably, the financing amount (i.e., in the currency of the selected foreign company) is less than or equal to the amount of the investing entity's investment in the domestic company.

Various other objects, advantages and features of the present invention will become readily apparent from the ensuing detailed description, and the novel features will be particularly pointed out in the appended claims.

### BRIEF DESCRIPTION OF THE DRAWINGS

These and other advantages of the present invention will be described in detail with reference to the following drawings in which like reference numbers refer to like elements:

FIG. 1 is a schematic diagram of an financing and investment structure in accordance with an embodiment of the present invention;

FIG. 2 is a flow chart describing the process of investing in a foreign company in accordance with an embodiment of the present invention; and

FIG. 3 is a schematic diagram of a computer based system for managing an investment in foreign country in accordance with an embodiment of the present invention.

### DETAILED DESCRIPTION OF THE EMBODIMENTS

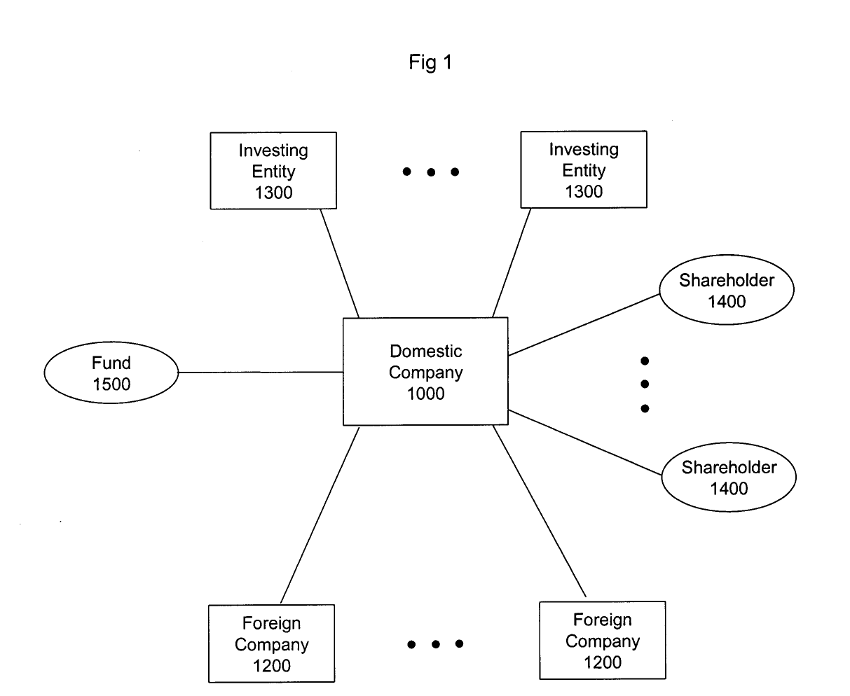

Turning now to FIG. 1, in accordance with an embodiment of the present invention, there is illustrated an investment structure, which comprises a private or publicly traded company 1000 (referred to herein as the “domestic company”) that owns or has rights to a portfolio of private and/or public companies 1200, including state owned enterprises, in another country (referred to herein as the “foreign companies”). The investor or a company 1300 (collectively referred to herein as the “investing entity”) invests in the domestic company 1000 to invest, acquire or manage one or more of the domestic company's portfolio of foreign companies 1200.

In accordance with an exemplary embodiment, the domestic company 1000 owns or has rights to a portfolio of public and/or private Chinese textile companies 1200. Alternatively, the domestic company 1000 may own or have rights to a portfolio of companies 1200 spanning many industries, e.g., textile, financial, insurance, hotel, etc. Much of the investment related work, such as identifying appropriate textile companies, legal and financial due diligence, agreements, etc., can be performed by the domestic company 1000 and/or its agents. The investing entity 1300 desirous of investing US $1 million in a Chinese textile company 1200 can now simply invest the $1 million in the domestic company 1000. For such investment in the domestic company 1000, the investing entity 1300 obtains a right or warrant to acquire, invest or manage one or more Chinese textile company 1200 in the domestic company's portfolio of Chinese textile companies 1200.

The Chinese textile companies 1200 benefits because they have access to foreign capital and is now part of a company in the developed capital market, e.g., a publicly listed US or European company. This provides added prestige and leverage to the Chinese textile companies in their home market because they have access to US or European capital and an opportunity to be affiliated with a US or European company.

In accordance with an embodiment of the present invention, the domestic company 1000 or its foreign agent (e.g., an affiliated or unrelated Chinese entity in this particular example) can provide or arrange credit facility, e.g., bank loan, to the investing entity 1300. Since the investing 1300 entity typically has no presence in foreign jurisdiction (i.e. China), they will have great difficulties in receiving capital from Chinese banks and financial institutions 3100. The domestic company 1000 and/or its foreign agent can arrange credit facility on behalf of the investing entity 1300. Preferably, the amount of the credit facility in the foreign country (i.e., China in this example) is limited to the amount equal to the investing entity's investment in the domestic company 1000. That is, the investing entity's investment in the domestic company 1000 can serve as collateral for this loan. The investing entity 1300 can then use this credit facility to invest, acquire, control or manage one or more of the Chinese textile companies 1200 from the domestic company 1000. This advantageously provides the investing entity 1300 with quick access to foreign capital by leveraging the domestic company's and/or its agent's financial and banking relationships in that foreign jurisdiction. Additionally, this advantageously enables the investing entity 1300 to quickly expand into foreign markets without building its own infrastructure in that foreign market.

In accordance with an embodiment of the present invention, a system 3000 is provided for managing the international financing and investment structure as described herein. The investment entity 1300 invests an investment amount in a domestic company 1000 of the present invention and is granted a right or warrant to invest, acquire, control or manage one or more foreign companies 1200 owned, controlled or managed by the domestic company 1000. That is, the investing entity 1300 selects one or more foreign companies 1200 owned or controlled by the domestic company 1000. The domestic company 1000 can own or control companies 1200 in only one foreign jurisdiction or multiple foreign jurisdictions. Also, the domestic company 1000 can own or control companies in one industry or multiple industries. The system 3000 initiates a process for opening credit facility on behalf of the investing entity 1300 in a jurisdiction of the foreign company 1200 selected by the investing entity 1300. The investing entity 1300 invests in the selected company using the fund available from the credit facility in the selected country. Preferably, the available fund is in the amount equal to or less than the amount of the investing entity's investment in the domestic company 1000. Alternatively, the investing entity 1300 can use the fund to acquire a controlling stake to manage the selected company or own the selected company in its entirety (this may depend on foreign ownership rules and regulations in the selected company).

In accordance with an embodiment of the present invention, the financing and investment structure of the present invention can be setup so various investing entities 1300 can invest in one type of industry in one country, in multiple industries in one country, one type of industry in multiple countries (e.g., a particular region or all over the world) or multiple industries in multiple countries. That is, the financing and investment structure can be setup so that investing entities 1300 in can invest in Indian outsourcing companies, Chinese textile companies, Chinese funeral homes, Asian hotels, European hotels, East European steel mills, cellular phone services in Asia, global pharmaceutical companies, etc.

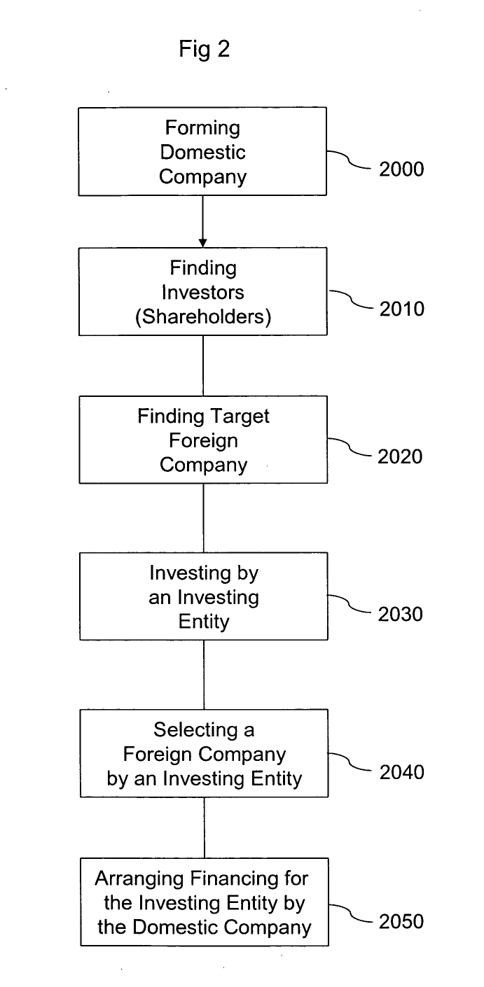

In accordance with an embodiment of the present invention, a method of investing in a foreign company is now described in conjunction with FIG. 2. A domestic company is formed or established in step 2000. In accordance with an aspect of the present invention, the domestic company 1000 is a publicly listed US company formed via any known methods complying with appropriate rules and regulations, e.g., a special purpose acquisition company (“SPAC”) or a blank check company, reverse-merger, reverse triangular merger and the like. A blank check company (i.e., a domestic company 1000) can be established for the purpose of acquiring foreign health care company. The underwriter or investment banker then solicits fund managers 1500, individual investors to invest in the company as shareholders 1400 in step 2010. The domestic company 1000 (i.e., a bank check company) and/or its agents (e.g., company's investment bankers) then searches for one or more suitable foreign health care companies 1200 to acquire or control in step 2020.

The investing entity 1300 invests in the domestic company 1000 in step 2030 and receives a right or warrant to invest, acquire, control or manage one or more foreign companies 1200 owned or controlled by the domestic company 1000. The investing entity 1300 then selects at least one foreign company 1200 from the plurality of foreign companies 1200 owned or controlled by the domestic company 1000 in step 2040. The domestic company 1000 arranges for financing directly or indirectly in a jurisdiction of the selected foreign company in step 2050, thereby enabling the investing entity 1300 to invest in the selected foreign company. Preferably, the financing amount is equal to or less than the investing entity's investment in the domestic company. In accordance with an aspect of the present invention, the financing amount is in currency of the foreign company 1200.

In accordance with an embodiment of the present invention, the domestic company 1000 selects the foreign companies 1200 based one or more financial/business criteria, such as EBITDA (earnings before interest, taxes, depreciation and amortization), annual revenue, net asset value, market share, annual sales, market capitalization for a public company and the like. In accordance with an exemplary embodiment of the present invention, the domestic company 1000 selects only foreign companies 1200 with net asset value greater than US $5 million.

Similarly, in accordance with an embodiment of the present invention, the domestic company 1000 accepts investment from an investing entity 1300 satisfying one or more financial/business criteria, e.g., investment amount, EBITDA, annual revenue, net asset value, market share, annual sales, market capitalization for a public company and the like. In accordance with an exemplary embodiment of the present invention, the domestic company selects only investing entities that can provide investment in excess of US $3 million.

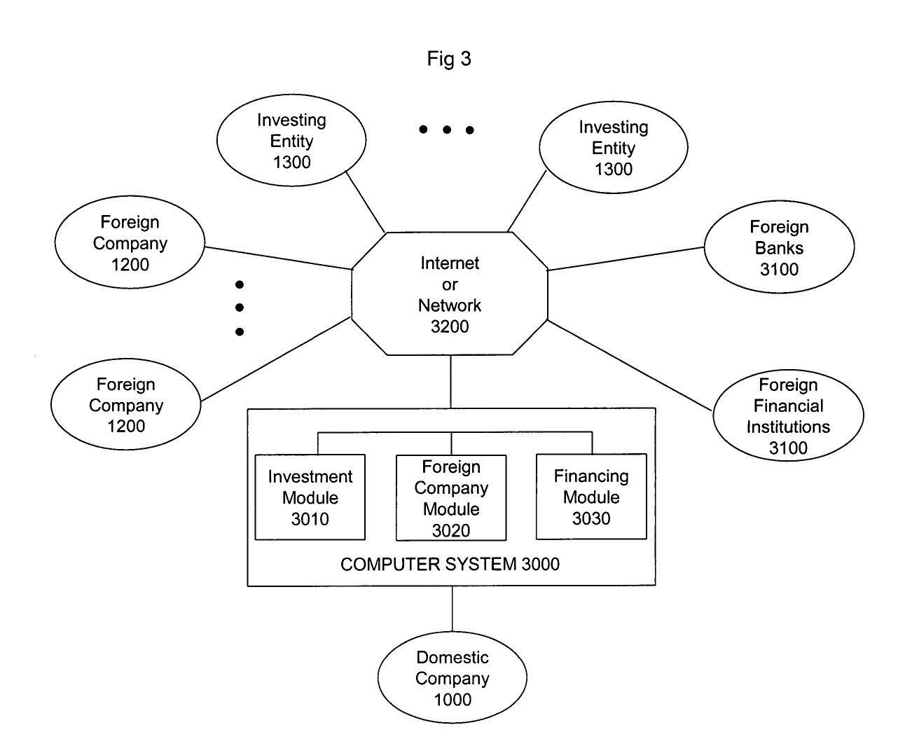

Turning now to FIG. 3, in accordance with an embodiment of the present invention, there is illustrated a computer based system 3000 for managing an investment in a foreign company, which is connected to the domestic company 1000, the foreign companies 1200, investing entities 1200 and foreign banks and financial institutions 3100 via a communications network 3200, e.g., Internet. Although, the domestic company 100 is shown to be connected to the computer system 3000 in FIG. 3, the domestic company can be connected to the computer system 3000 via the network 3200. The computer system 3000 comprises an investment module 3010, a foreign company module 3020 and a financing module 3030. The investment module 3010 processes investment by an investing entity 1300 in a domestic company 1000 holding interests in a plurality of foreign companies 1200. The foreign company module 3020 enables the investing entity 1300 to select at least one foreign company 1200 from the plurality of foreign companies 1200. Preferably, the foreign company module 3020 provides description, including financial information, of each foreign company 1200. The financing module 3030 arranges financing for the investing entity 1300 in a jurisdiction of the selected foreign company 1200 through a local foreign bank or financial institution 3100, thereby enabling the investing entity 1300 to invest in the selected foreign company 1200. Preferably, the financing amount (i.e., in the currency of the selected foreign company) is less than or equal to the amount of the investing entity's investment in the domestic company 1000.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described herein. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A financing and investment structure comprising a financing instrument, which is based on an investing entity's investment in a domestic company holding interests in a plurality of foreign companies, for investing by said investing entity in one of said plurality of foreign companies.

2. The financing and investment structure of claim 1, wherein the amount of said financing instrument is equal to or less than said investing entity's investment in said domestic company.

3. The financing and investment structure of claim 1, wherein said investing entity selects a foreign company from said plurality of foreign companies and wherein said financing instrument is available in a local currency of said selected foreign company.

4. The financing and investment structure of claim 1, wherein said plurality of foreign companies comprises companies in one industry in one country.

5. The financing and investment structure of claim 1, wherein said plurality of foreign companies comprises companies in multiple industries in one country.

6. The financing and investment structure of claim 1, wherein said plurality of foreign companies comprises companies in one industry in multiple countries.

7. The financing and investment structure of claim 1, wherein said plurality of foreign companies comprises companies in multiple industries in multiple countries.

8. The financing and investment structure of claim 1, wherein said domestic company is a private company.

9. The financing and investment structure of claim 1, wherein said domestic company is a public company.

10. The financing and investment structure of claim 9, wherein said public company is formed via one of the following: reverse-merger or special purpose acquisition company (SPAC).

11. The financing and investment structure of claim 1, wherein each of said foreign companies is one of the following: a private or public company.

12. A system for managing the financing and investment structure of claim 1.

13. A method of investing in a foreign company, comprising the steps of:
investing in a domestic company holding interests in a plurality of foreign companies by an investing entity;
selecting at least one foreign company from said plurality of foreign companies; and
arranging financing in a jurisdiction of said foreign company, thereby enabling said investing entity to invest in said selected foreign company.

14. The method of claim 13, wherein the step of arranging financing arranges financing in a currency of said foreign company.

15. The method of claim 13, wherein the step of arranging financing arranges financing in currency of said foreign company in the amount less than or equal to the amount of investment in said domestic company by said investing entity.

16. The method of claim 13, further comprising the steps of selecting foreign companies based on predetermined criteria.

17. The method of claim 13, further comprising the steps of receiving investment from said investing entity satisfying predetermined criteria.

18. A computer based system for managing an investment in a foreign company, comprising:
an investment module for processing investment by an investing entity in a domestic company holding interests in a plurality of foreign companies;
a foreign company module for enabling said investing entity to select at least one foreign company from said plurality of foreign companies; and
a financing module for arranging financing in a jurisdiction of said selected foreign company, thereby enabling said investing entity to invest in said selected foreign company.

19. The computer based system of claim 18, wherein said financing module is operable to arrange financing in a currency of said foreign company in the amount equal to the amount of investment in said domestic company by said investing entity, thereby enabling said investing entity to invest in said selected foreign company.

20. The computer based system of claim 18, wherein said foreign company modules is operable to provide information about each of said plurality of foreign companies.
